(19) United States
(12) Patent Application Publication
(10) Pub. No.: US 2008/0241718 A1
(43) Pub. Date: Oct. 2, 2008

(54) Method and Device for Receiving a Used Web of Transfer Foil

(75) Inventor: Alexander Weber, Weinheim (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AG, Heidelberg (DE)

(21) Appl. No.: 12/056,861

(22) Filed: Mar. 27, 2008

(30) Foreign Application Priority Data
Mar. 28, 2007 (DE) 10 2007 015 379.3
Apr. 16, 2007 (DE) 10 2007 017 799.4

(51) Int. Cl. G03G 13/14; G03G 15/02

(52) U.S. Cl. 430/48; 399/168

(57) ABSTRACT

A method and device for receiving a used web of transfer foil on a wind-up reel overcome the disadvantage of telescoping of the wound-up web of transfer foil on the wind-up reel, which tends to increase as a used web of transfer foil continues to be fed to the wind-up reel. Telescoping is at least reduced by providing a device for receiving a used web of transfer foil with at least one dielectric layer, causing web regions adjacent each other in the radial direction on the wind-up reel to adhere to each other due to electrostatic forces. At least one charging device for charging the dielectric layer of the web of transfer foil is provided in a transfer foil web region upstream of the wind-up reel, to charge the used web of transfer foil. The charging device substantially extends over the entire width of the web of transfer foil.

### CROSS-REFERENCE TO RELATED APPLICATIONS

This application claims the priority, under 35 U.S.C. § 119, of German Patent Applications DE 10 2007 015 379.3, filed Mar. 28, 2007 and DE 10 2007 017 799.4, filed Apr. 16, 2007; the prior applications are herewith incorporated by reference in their entirety.

### BACKGROUND OF THE INVENTION

### Field of the Invention

The present invention relates to a method and device for receiving a used web of transfer foil on a wind-up reel.

Various foil transfer devices are used to enhance printed products, for example to produce glossy effects. Those machines can be subdivided into hot-foil stamping machines and cold-foil stamping machines.

In cold-foil stamping, a transfer layer of a transfer foil is transferred under pressure to a printing substrate. In a preceding step, an adhesive has been applied to the printing substrate in accordance with the image to be stamped in order to cause the printing substrate to accept the transfer layer. The application of the adhesive is usually carried out in a conventional printing unit in which a plate cylinder cooperates with a blanket cylinder to transfer the adhesive to the printing substrate just like regular printing ink. Having received the adhesive, the printing substrate is fed through a transfer unit, which in general is likewise a conventional printing unit. In that transfer unit, a transfer cylinder and an impression cylinder form a transfer nip. The printing substrate, which has received the adhesive, and the transfer foil pass the transfer nip together, so that a transfer layer is transferred under pressure from the transfer foil to the printing substrate. In the process, the transfer layer adheres to the printing substrate regions that carry the adhesive.

The web of transfer foil is supplied to the transfer unit on a foil supply reel. The web of foil is unwound from the foil supply reel to be guided through the transfer nip together with the printing substrate. Then the used transfer foil, from which the transfer layer has been removed at least in some areas, is wound onto a foil collecting reel or wind-up reel. Such a device for transferring foil, in particular cold foil, is described in European Patent No. 0 578 706 B1, corresponding to U.S. Pat. Nos. 5,565,054 and 5,735,994.

In order to ensure that the web of foil is wound up correctly, German Published Non-Prosecuted Patent Application DE 101 16 973 A1, corresponding to U.S. Pat. No. 6,752,348, discloses electrostatically charging a leading end section of the web of foil to provide greater accuracy when the web of foil is initially wound up.

Even though the prior art provides ways and means of improving the initial winding-up of a web of foil on a wind-up reel by improving the connection between the reel and the web of foil, the subsequent wind-up process of the web of foil on the reel that then carries at least one layer of foil turns out to be problematic. As more and more foil is wound up onto the reel, there is an increasing tendency of the web of foil to “telescope” on the wind-up reel. In this context, “to telescope” is understood to mean that web sections that are spaced apart from each other in the radial direction slide with respect to each other on the wind-up reel in the axial direction. The windings on the reel virtually run to the side in an outward direction like a telescope, i.e. they telescope.

On one hand, the telescoping of the wind-up reel may create a hazard because the telescoped wind-up reel may reach into other parts of the machine. On the other hand, telescoping has a negative influence on the rotation behavior of the wind-up reel. In general, the process of winding up the web of foil needs to be stopped to reverse the telescoping effect. It may even become necessary to exchange the entire wind-up reel and to prepare a new wind-up reel. Those measures delay the foil transfer process, and the provision of a new wind-up reel, which may be necessary as indicated above, increases the material consumption.

### BRIEF SUMMARY OF THE INVENTION

It is accordingly an object of the invention to provide a method and a device for receiving a used web of transfer foil, which overcome the herein aforementioned disadvantages of the heretofore-known methods and devices of this general type and which at least reduce telescoping of the web of foil.

With the foregoing and other objects in view there is provided, in accordance with the invention, a method for receiving a used web of transfer foil on a wind-up reel. The method comprises providing a web of transfer foil substantially formed of an airtight plastic foil as a carrier layer suitable for carrying a transfer layer to be transferred at least partially from the web of transfer foil to a printing substrate before the web of transfer foil is received on a wind-up reel. The web of transfer foil is positively or negatively charged, preferably over the entire width, to cause transfer foil web sections situated on top of each other on the wind-up reel to adhere to each other due to electrostatic forces.

The device of the invention for receiving a used web of transfer foil, including at least one dielectric layer, on a wind-up reel, includes at least one charging device extending substantially over the entire width of the web of transfer foil to charge the dielectric layer of the web of transfer foil in a web region upstream of the wind-up reel.

As a result of the charging of the dielectric layer of the web of transfer foil, the individual wraps or layers of the web of foil adhere to each other in the radial direction on the wind-up reel. Tangential or axial movement is advantageously prevented.

Advantageously, the web of transfer foil may have a dielectric carrier layer. For reasons of simplicity of the structure, this carrier layer may preferably be airtight.

Cold-foil stamping devices that are operated in a material-saving way, as it is known from the prior art and described, for example, in German Published Non-Prosecuted Patent Application DE 198 42 585 A1, corresponding to U.S. Pat. No. 6,230,616 and European Patent EP 718 099 B1, corresponding to U.S. Pat. No. 5,611,272, have an additional problem that air bubbles may form in the wound-up web due to the irregular movement of the web of foil. Those bubbles may even increase the telescoping of the web of foil. An additional advantage of establishing static attraction between the wraps or layers of the web that are already present on the reel and the latest wrap or layer of foil is that air bubbles are advantageously expelled from the wound-up web on the reel. This expulsion of the air bubbles may additionally be enhanced in an advantageous way by providing a roller that engages the wound-up web of transfer foil on the reel.

Continuous electric charging of the dielectric layer of the web of transfer foil, i.e. of the carrier layer, achieves particularly strong static adherence in accordance with the invention. Thus, the entire lengths of the webs are wound up in a stable way.

In accordance with another mode of the invention, the web of transfer foil may include at least two web strands, and these at least two separate strands of the web of transfer foil are charged in accordance with the method of the invention.

As a consequence, two different transfer foils can advantageously be used, in particular in a cold-foil stamping process, to transfer a transfer layer to two different regions of the printing substrate.

In accordance with a further mode of the invention, a charging device that extends substantially over the entire width of the web of transfer foil or of all web strands of the web of transfer foil is used to charge the web of transfer foil or multiple web strands. This represents a particularly simple embodiment and a simple method for charging all web strands at the same time, so that they can be wound up on separate wind-up reels or on a common wind-up reel. In particular, it is possible to provide different wind-up reels for the individual web strands and to dispose the different reels on a common shaft. Thus, a charging device in accordance with the invention that extends over the entire width of the format of the web of transfer foil or of all web strands simultaneously charges all web strands in a simple way, and telescoping is prevented on all wind-up reels (for the entire web or for individual web strands) and on separate or common shafts.

In accordance with an added mode of the invention, the charging device includes a charging electrode and a conductive surface as an antipole, and the web of transfer foil or multiple web strands pass between the charging electrode and the conductive surface and are charged by the current flowing between the charging electrode and the conductive surface.

In accordance with an additional mode of the invention, in order to provide good charging of the web of transfer foil without subjecting the charging electrode to excessive wear, the distance between the conductive surface and the charging electrode is advantageously 0-30 mm, preferably 20 mm.

The voltage impressed between the charging electrode and the conductive surface is possibly up to 30 kV, preferably between 15 and 20 kV.

In accordance with yet another mode of the invention, the conductive surface may be a plate, a rod, a cylinder, or a deflection roller. In particular, the conductive surface may be rigid. However, a rotatable deflection roller is preferred as the conductive surface.

In accordance with yet a further mode of the invention, the web of transfer foil wraps around the deflection roller at an angle of wrap of more than 20°, preferably more than 90°, in order to achieve a larger area of contact between the web of transfer foil and the conductive surface. This provides improved charging of the web of transfer foil.

In accordance with yet an added mode of the invention, the charging device for charging the web of transfer foil or the web strands advantageously includes a corona electrode or a chargeable deflection roller. A corona electrode, in particular, minimizes the distance between the charging of the web of transfer foil and the wind-up reel. Consequently, the amount of charge that remains on the wound-up web is as high as possible.

Due to the use of a chargeable deflection roller as part of the charging device in accordance with the invention, the structure of the device can be very simple. In general, deflection rollers are present in the device anyway to guide the web of transfer foil, for example a web of transfer foil suitable for cold-foil stamping. The use of one of these deflection rollers or of at least one of these deflection rollers as the electrode for charging the web of transfer foil thus presents a structural simplification of the device, avoiding the introduction of further elements into the device for transferring foil. If a chargeable deflection roller is used to charge the web of transfer foil, it is to be considered that the deflection roller comes into contact with the dielectric side of the web of transfer foil if a transfer foil is used.

In accordance with yet an additional mode of the invention, it is particularly favorable to use a web of transfer foil in a foil transfer unit and to charge the dielectric layer of the transfer foil, which is formed by the carrier layer of the transfer foil. The invention includes using a web of transfer foil with a carrier layer that is suitable for carrying a transfer layer, and positively or negatively charging that side of the carrier layer that faces away from the transfer layer.

With the objects of the invention in view, there is concomitantly provided, in an apparatus employing a web of transfer foil including at least one dielectric layer in the form of a carrier layer substantially formed of an airtight plastic foil suitable for receiving a transfer layer and at least partially transferring the transfer layer to a printing substrate in a foil transfer process, a device for receiving the web of transfer foil after use. The device comprises a wind-up reel and at least one charging device disposed in a transfer foil web region upstream of the wind-up reel, for preferably continuously charging the dielectric layer of the web of transfer foil. The at least one charging device extends substantially over an entire width of the web of transfer foil.

Other features which are considered as characteristic for the invention are set forth in the appended claims.

Although the invention is illustrated and described herein as embodied in a method and a device for receiving a used web of transfer foil, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, cross-sectional view of a transfer foil;

FIG. 2 is a side-elevational view of a foil transfer unit with a receiving device for receiving a used transfer foil;

FIG. 3 is a front-elevational view of a receiving device for receiving the used transfer foil; and

FIG. 4 is a side-elevational view of a preferred receiving device.

### DETAILED DESCRIPTION OF THE INVENTION

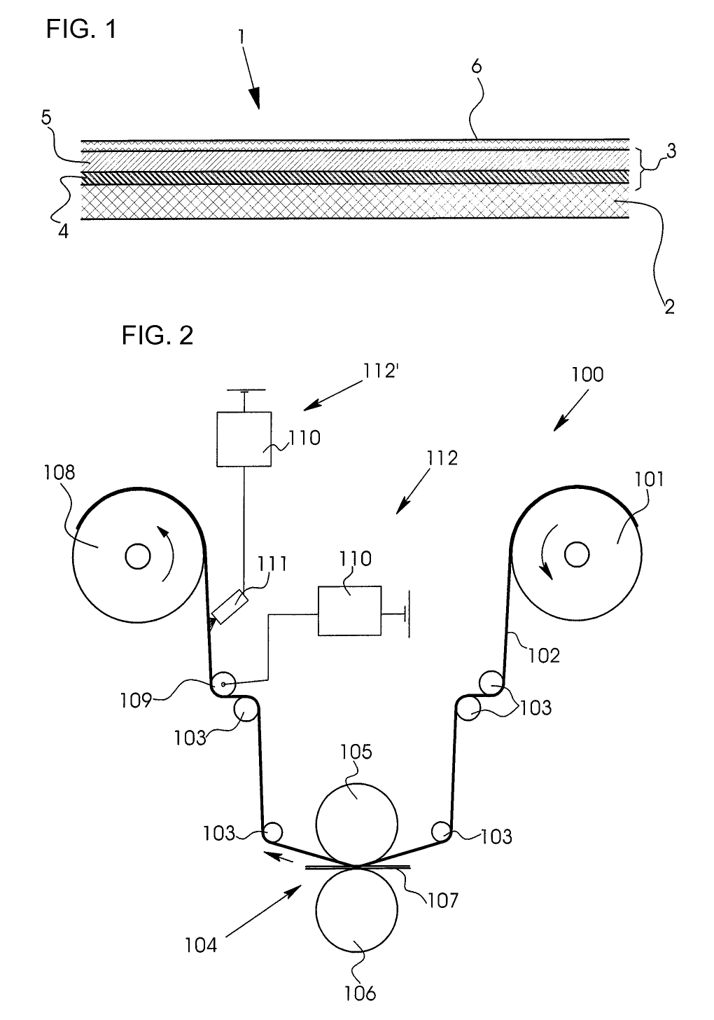

Referring now to the figures of the drawings in detail and first, particularly, to FIG. 1 thereof, there is seen a possible structure of a conventional transfer foil 1.

The transfer foil 1 includes an airtight plastic foil as a carrier layer or foil 2, which usually has dielectric properties. The carrier foil 2 carries a transfer layer 3, which is formed by a separation layer 4 and a metal layer 5. An additional layer in the form of an adhesion-promoting agent 6 may be provided on the transfer layer to establish better contact between the transfer foil 1 and regions on a printing substrate that carry an adhesive. The metal layer 5 may, in particular, be formed by a layer of varnish mixed with colored metal particles. In an alternative exemplary embodiment of such a transfer foil 1, a different, non-metallic colored layer may be provided instead of the metal layer 5 to be transferred to regions on the printing substrate that carry an adhesive.

In particular, a colored or transparent layer of varnish 4 with a metallic layer 5 vaporized thereon may be provided on the carrier foil 2 as the separation layer. The adhesion-promoting agent 6 is provided on this metallic layer 5. Once the transfer has been completed, the layer of varnish 4 on the transfer layer 3 that has been transferred acts as a protective layer.

FIG. 2 illustrates a transfer unit 100, which may be provided, for example, in a printing press that is not illustrated in any further detail. In particular, it may include at least parts of a conventional printing unit.

The transfer unit 100 includes a foil supply reel 101 with a supply of transfer foil 1 in the shape of a web of foil 102. The web of foil 102 is guided through a transfer nip 104 by deflection rollers 103. The web of foil 102 is guided through the transfer nip 104 together with a sheet 107. An adhesive has been applied to the sheet 107 in accordance with an image, in a non-illustrated application unit, which may be a printing unit of a conventional printing press. In the transfer nip 104, the transfer layer 3 of the transfer foil 1 is removed from the carrier foil 2 of the transfer foil 1 in those regions of the sheet 107 that carry the adhesive, and is transferred to the sheet 107 under pressure. The required pressure is provided by a transfer cylinder 105, which is in engagement with an impression cylinder 106 and forms the transfer nip 104 with the latter. The transfer cylinder 105 may, in particular, be a blanket cylinder of a conventional printing unit.

After the foil transfer, i.e. once the transfer layer 3 has been transferred to the sheet 107, deflection rollers 103 guide the used web of foil 102 to a foil wind-up reel 108 in a direction indicated by an arrow. The wind-up reel 108 rotates in the direction of the arrow to take up the used web of foil 102.

Two charging devices 112 and 112′ for preventing the used web of foil 102 on the wind-up reel 108 from telescoping are illustrated in FIG. 2. One or both of the charging devices may be associated with the used web of foil 102. It is also possible to provide only one charging device 112 or 112′. The configuration illustrated in FIG. 2 is to be understood to be only one possible example, which also serves to illustrate possible embodiments with only one charging device 112 or 112′.

The web of foil 102 is guided in such a way that the transfer layer 3 of the transfer foil 1 can be transferred to the sheet 107 in the transfer nip 104. In the process, the dielectric carrier foil 2 of the transfer foil 1 faces the transfer cylinder 105. In order to prevent the charge to be applied from spreading on the metallic side of the transfer foil 1, the charging devices 112, 112′ are assigned to the side of the carrier foil side of the transfer foil 1 facing away from the transfer layer 3.

In the illustrated example, the charging device 112 includes a charged deflection roller 109, which is assigned to the back side of the transfer foil 1. The transfer foil 1 wraps around the charged deflection roller 109 in such a way that the carrier foil 2 is in direct contact with the charged deflection roller 109 and is thus positively or negatively charged by the deflection roller 109. The type of charge is irrelevant in this context. In particular, it may be a static charge, so that charge carrier separation takes place in the carrier foil 2. Thus, the transfer foil 1, i.e. the web of foil 102, is charged in such a way that the carrier foil side facing away from the transfer layer 3 is positively charged, for example, and the carrier foil side facing the transfer layer 3 is negatively charged. The web of foil 102 that has been charged in this way is wound onto the wind-up reel 108. Adjacent regions of the web of foil 102 on the wind-up reel 108 attract each other in the radial direction. This radial force acts on every portion of the transfer foil 1 and creates a frictional force that must be overcome for telescoping of the web of foil 102 to be possible. In other words, this radial force prevents the web of foil 102 from telescoping on the wind-up reel 108.

The charging device 112 includes a high voltage DC generator 110 in order to charge the charged deflection roller 109.

The further charging device 112′ is provided alternatively or in addition. The further charging device 112′ includes a corona electrode 111, which is supplied with a direct current from a high voltage generator 110 to charge the carrier foil 2 in the manner described above.

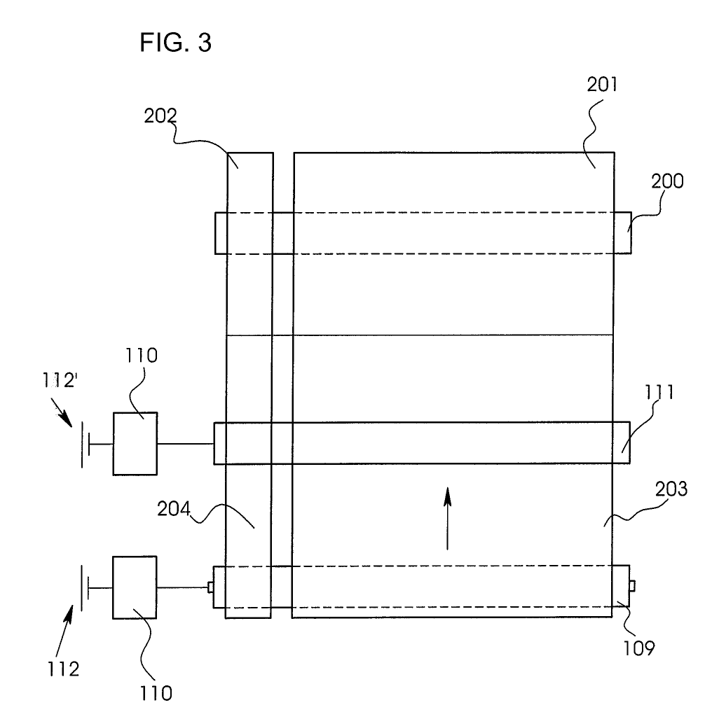

FIG. 3 shows a device for receiving a used web of transfer foil, in this case a used web of foil 102 as shown in FIG. 2.

In the illustrated example, two separate foil strands 203, 204, instead of one web of transfer foil, pass through the transfer nip 104 to transfer a transfer layer 3 to different regions of a sheet 107 independently of each other. In this case, too, deflection rollers 103 guide these foil strands 203, 204 from (non-illustrated) foil strand supply reels through the transfer nip 104 and finally to illustrated foil strand wind-up reels 201, 202, which are provided on a common shaft 200. The shaft 200 may, in particular, be a friction shaft.

The foil strands 203, 204 wrap around the charged deflection roller 109 in such a way that their carrier foil side 2 contacts the charged transfer roller 109. The charged transfer roller 109 extends perpendicular to the direction of travel of the foil strands 203, 204 as indicated by an arrow, and spans the entire width of all foil strands 203, 204. Thus, only one charged deflection roller 109 is necessary to charge and simultaneously deflect both webs of transfer foil 203, 204 and thus to prevent the foil strands 203, 204 from telescoping on the respective foil strand wind-up reels 201, 202. As described above, the charged deflection roller 109 is likewise charged by a high voltage DC generator 110.

As an alternative or in addition to the charged roller 109 of a charging device 112, it is possible to provide a corona electrode 111 as part of the charging device 112′ illustrated in FIG. 3. Like the charged deflection roller 109, the corona electrode 111 extends over the entire width of the format of all foil strands 203, 204 and charges the entire surface of the web strands 203, 204 through the use of a charging current.

All foil strands 203, 204 or a single web of foil 102 are charged through the use of one or both of the charging devices 112, 112′ in such a way that regions of the web of foil that are spaced apart in the radial direction on the respective wind-up reel 108, 201, 202 attract each other in such a way that axial sliding, i.e. telescoping, of the individual foil strands 203, 204 or of the web of foil 102 is prevented.

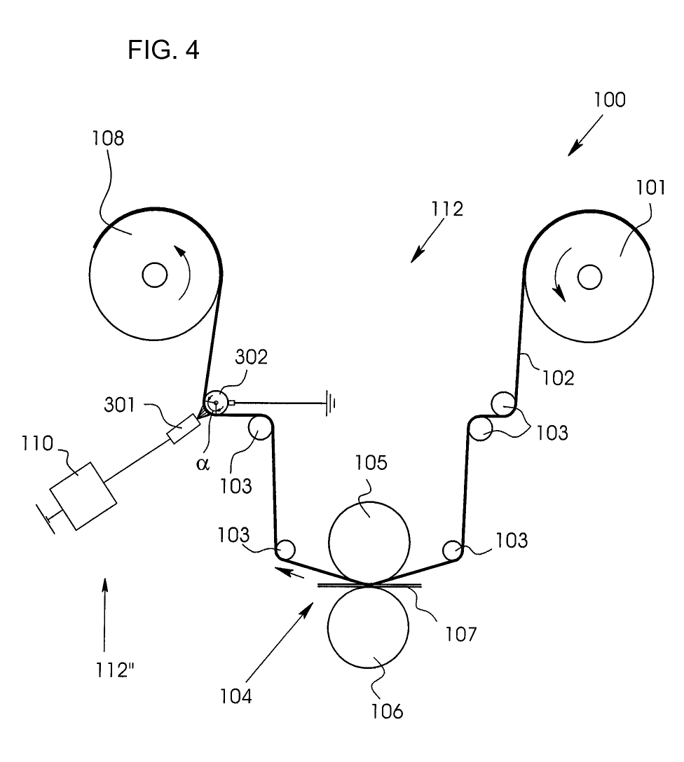

FIG. 4 illustrates a particularly preferred receiving device for receiving a used transfer foil 1.

FIG. 4 is a side view of the receiving device in a transfer unit 100. Identical elements that have been described already in connection with FIG. 2 have the same reference numerals. As described in the context of FIG. 2, the web of foil 102 is guided by deflection rollers 103. The transfer of the transfer layer 3 from the transfer foil 1 to a printing substrate 107 takes place in the same way as described with reference to FIG. 2.

In order to prevent the transfer foil on the wind-up reel 108 from telescoping, the used transfer foil 1 is charged at a deflection roller with a conductive surface 302. The web of foil 102 wraps around this deflection roller 302 in such a way that the carrier foil 2 of the transfer foil 1 contacts the conductive surface of the deflection roller 302.

A charging electrode 301, which is operated by a high voltage generator 110, establishes a potential between the charging electrode 301 and the conductive surface of the deflection roller 302. In the illustrated example, the surface of the deflection roller 302 is grounded. Alternatively, the deflection roller 302 may be oppositely charged relative to the charging electrode 301.

The voltage may vary between 0 and 30 kV. For example, for a very wide web of foil 102, virtually no charge is necessary and the voltage may be 0 V. For narrow webs of foil 102 or foil strands 203, 204, voltages between 15 kV and 20 kV are preferred. In particular, this voltage may be controlled automatically, i.e. in a closed loop, for example depending on the development of the telescoping effect.

The voltage difference between the charging electrode 301 and the conductive surface of the deflection roller 302 causes a discharge between the charging electrode 301 and the deflection roller 302.

As described above, the web of foil 102 is guided around the deflection roller 302. In the process, the web of foil 102 does not come into contact with the charging electrode 301. Instead, the web of foil 102 is charged as a result of the discharge between the charging electrode 301 and the deflection roller 302. For this purpose, the web of foil 102 is passed between the charging electrode 301 and the deflection roller 302. In accordance with the invention, no contact between the web of foil 102 and the charging electrode 301 is intended. Thus, a distance of 20 mm is provided between the surface of the deflection roller 302 and the discharge tip of the charging electrode 301.

In accordance with the invention, the charging of the carrier foil 2 of the transfer foil 1 is at least assisted by contact with the conductive surface of the deflection roller 302. In order to achieve a highly effective charging of the web of foil 102, the web of foil wraps around the deflection roller 302 in an angle of wrap α. In this context, the angle of wrap α is preferably more than 90°, as shown in the drawing. In this way, the charging of the web of foil 102 is optimized so that the adhesive forces in the web of foil 102 effectively prevent the web of foil 102 from telescoping.

1. A method for receiving a used web of transfer foil on a wind-up reel, the method comprising the following steps:
providing a web of transfer foil substantially formed of an airtight plastic foil as a carrier layer suitable for carrying a transfer layer to be transferred at least partially from the web of transfer foil to a printing substrate before the web of transfer foil is received on a wind-up reel; and
positively or negatively charging the web of transfer foil to cause transfer foil web sections situated on top of each other on the wind-up reel to adhere to each other due to electrostatic forces.

2. The method according to claim 1, which further comprises carrying out the step of charging the web of transfer foil over an entire width of the web of transfer foil.

3. The method according to claim 1, which further comprises carrying out the charging step by charging at least two separate web strands of the web of transfer foil.

4. The method according to claim 1, which further comprises carrying out the charging step with a charging device extending substantially over an entire width of the web of transfer foil or multiple web strands for charging the web of transfer foil or all of the web strands.

5. The method according to claim 1, which further comprises carrying out the charging step by charging the web of transfer foil or multiple web strands continuously and not merely momentarily.

6. The method according to claim 4, which further comprises:
carrying out the charging step with a charging device including a charging electrode and a conductive surface as an antipole to the charging electrode, and
passing the web of transfer foil or multiple web strands between the charging electrode and the conductive surface for charging with a current flowing between the charging electrode and the conductive surface.

7. The method according to claim 5, which further comprises:
carrying out the charging step with a charging device including a charging electrode and a conductive surface as an antipole to the charging electrode, and
passing the web of transfer foil or multiple web strands between the charging electrode and the conductive surface for charging with a current flowing between the charging electrode and the conductive surface.

8. The method according to claim 6, wherein the charging electrode is disposed at a distance of between 0 and 30 mm from the conductive surface.

9. The method according to claim 6, wherein the charging electrode is disposed at a distance of 20 mm from the conductive surface.

10. The method according to claim 7, wherein the charging electrode is disposed at a distance of between 0 and 30 mm from the conductive surface.

11. The method according to claim 7, wherein the charging electrode is disposed at a distance of 20 mm from the conductive surface.

12. The method according to claim 6, wherein the conductive surface is a surface of a plate, a rod, a cylinder or a deflection roller.

13. The method according to claim 7, wherein the conductive surface is a surface of a plate, a rod, a cylinder or a deflection roller.

14. The method according to claim 12, wherein the web of transfer foil or multiple web strands wrap around a deflection roller at an angle of wrap of more than 20°.

15. The method according to claim 12, wherein the web of transfer foil or multiple web strands wrap around a deflection roller at an angle of wrap of more than 90°.

16. The method according to claim 13, wherein the web of transfer foil or multiple web strands wrap around a deflection roller at an angle of wrap of more than 20°.

17. The method according to claim 13, wherein the web of transfer foil or multiple web strands wrap around a deflection roller at an angle of wrap of more than 90°.

18. The method according to claim 4, wherein the charging device is a corona electrode for contact-free charging.

19. The method according to claim 5, wherein the charging device is a corona electrode for contact-free charging.

20. The method according to claim 4, wherein the charging device is a contacting electrode.

21. The method according to claim 5, wherein the charging device is a contacting electrode.

22. The method according to claim 20, wherein the contacting electrode is a charged deflection roller.

23. The method according to claim 21, wherein the contacting electrode is a charged deflection roller.

24. The method according to claim 1, which further comprises carrying out the step of positively or negatively charging the web of transfer foil on a side facing away from the transfer layer.

25. In an apparatus employing a web of transfer foil including at least one dielectric layer in the form of a carrier layer substantially formed of an airtight plastic foil suitable for receiving a transfer layer and at least partially transferring the transfer layer to a printing substrate in a foil transfer process, a device for receiving the web of transfer foil after use, the device comprising:
a wind-up reel; and
at least one charging device disposed in a transfer foil web region upstream of said wind-up reel, for charging the dielectric layer of the web of transfer foil, said at least one charging device extending substantially over an entire width of the web of transfer foil.

26. The device according to claim 25, wherein said at least one charging device continuously charges the dielectric layer.

27. The device according to claim 12, wherein the web of transfer foil includes at least two web strands.

28. The device according to claim 25, wherein said charging device includes at least one charging electrode and a conductive surface as an antipole to said charging electrode, for receiving the web of transfer foil or a web strand between said charging electrode and said conductive surface.

29. The device according to claim 28, wherein said charging electrode is disposed at a distance of between 0 and 30 mm from said conductive surface.

30. The device according to claim 28, wherein said charging electrode is disposed at a distance of 20 mm from said conductive surface.

31. The device according to claim 28, wherein said conductive surface is a surface of a plate, a rod, a cylinder or a deflection roller.

32. The device according to claim 25, wherein said charging device includes a corona electrode.

33. The device according to claim 25, wherein said charging device is a chargeable deflection roller for the web of transfer foil or multiple web strands.

34. The device according to claim 25, wherein the web of transfer foil is a web of transfer foil of a foil transfer unit.

35. An apparatus for carrying out a foil transfer process, the apparatus comprising:
a web of transfer foil including at least one dielectric layer in the form of a carrier layer substantially formed of an airtight plastic foil suitable for receiving a transfer layer and at least partially transferring said transfer layer to a printing substrate in the foil transfer process; and
a device for receiving said web of transfer foil after use, said device including a wind-up reel, and at least one charging device disposed in a transfer foil web region upstream of said wind-up reel, for charging said dielectric layer of said web of transfer foil, said at least one charging device extending substantially over an entire width of said web of transfer foil.

36. The apparatus according to claim 35, wherein said at least one charging device continuously charges said dielectric layer.
